(19) United States
(12) Patent Application Publication
(10) Pub. No.: US 2020/0019133 A1
(43) Pub. Date: Jan. 16, 2020

(54) SEQUENCE GENERATING APPARATUS AND CONTROL METHOD THEREOF

(71) Applicant: CANON KABUSHIKI KAISHA, Tokyo (JP)

(72) Inventor: Koichi Takeuchi, Yokohama-shi (JP)

(21) Appl. No.: 16/578,961

(22) Filed: Sep. 23, 2019

Related U.S. Application Data
(63) Continuation of application No. PCT/JP2018/009403, filed on Mar. 12, 2018.

(30) Foreign Application Priority Data
Mar. 30, 2017 (JP) 2017-068743

(51) Int. Cl. G05B 19/045

(52) U.S. Cl. CPC G05B 19/045; G05B 2219/23289; G05B 2219/23258

(57) ABSTRACT

A sequence generating apparatus that generates a sequence representing a state transition of an object, includes input unit configured to input an initial state of the object in a sequence to be generated; setting unit configured to set an end state of the object in the sequence to be generated; generating unit configured to generate a plurality of sequences using a predetermined prediction model on the basis of the initial state; and output unit configured to output at least one of the plurality of sequences, the at least one sequence matching the end state.

### CROSS-REFERENCE TO RELATED APPLICATIONS

This application is a Continuation of International Patent Application No. PCT/JP2018/009403, filed Mar. 12, 2018, which claims the benefit of Japanese Patent Application No. 2017-068743, filed Mar. 30, 2017, both of which are hereby incorporated by reference herein in their entirety.

### TECHNICAL FIELD

The present invention relates to a technique for efficiently generating diverse sequences.

### BACKGROUND ART

An ordered set of element data items is called a sequence. Element data is data that represents a momentary state of a person, thing, or event of interest. There are various types of sequences. For example, a behavior is a sequence that includes motion categories and coordinates representing the position of an object as element data, and a video is a sequence that includes images as element data. In recent years, there have been various recognition techniques using sequences. Examples of such techniques include human behavior recognition techniques using video sequences, and speech recognition techniques using speech sequences. These recognition techniques using sequences may use machine learning as a technical basis. In machine learning, it is important to ensure diversity of data used for learning and evaluation. Therefore, when sequences are used as data for machine learning, it is preferable to collect a diverse range of data.

Examples of sequence collecting methods include a method that observes and collects phenomena that have actually occurred, a method that artificially generates sequences, and a method that randomly generates sequences. Japanese Patent Laid-Open No. 2002-259161 discloses a technique in which, for software testing, screen transition sequences that include software screens as element data are exhaustively generated. Also, Japanese Patent Laid-Open No. 2002-83312 discloses a technique in which, for generating an animation, a behavioral sequence corresponding to an intension (e.g., “heading to destination”) given to a character is generated.

However, the sequence collecting methods described above have various problems. For example, when video sequences are collected on the basis of videos recorded using a video camera, the recorded videos are dependent on phenomena occurring during recording. Therefore, the method described above is not efficient in collecting sequences related to less frequent phenomena. Also, when behavioral sequences are manually set to artificially generate sequences, the operating cost required to exhaustively cover diverse sequences is high. When sequences are randomly generated, unnatural sequences that seem unlikely to actually occur may be generated. The techniques disclosed in Japanese Patent Laid-Open No. 2002-259161 and Japanese Patent Laid-Open No. 2002-83312 are not designed to solve the problems described above.

The present invention has been made in view of the problems described above. An object of the present invention is to provide a technique that can efficiently generate diverse and natural sequences.

### SUMMARY OF INVENTION

To solve the problems described above, a sequence generating apparatus according to the present invention includes the following components. That is, a sequence generating apparatus that generates a sequence representing a state transition of an object includes input unit configured to input an initial state of the object in a sequence to be generated; setting unit configured to set an end state of the object in the sequence to be generated; generating unit configured to generate sequences using a predetermined prediction model on the basis of the initial state; and output unit configured to output at least one of the sequences, the at least one sequence matching the end state.

Further features of the present invention will become apparent from the following description of exemplary embodiments with reference to the attached drawings.

### BRIEF DESCRIPTION OF DRAWINGS

FIG. 1 is a diagram illustrating an example of a sequence.

FIG. 2 is a diagram illustrating an example of a configuration of a sequence generating system according to a first embodiment.

FIG. 3 is a diagram illustrating an example of a GUI of an end state setting unit.

FIG. 4 is a diagram illustrating an example of a GUI of a diversity setting unit.

FIG. 5 is a diagram illustrating examples of processing steps of a sequence generating unit.

FIG. 6 is a flowchart illustrating a process performed by the sequence generating system.

FIG. 7 is a diagram illustrating an example of a complex sequence.

FIG. 8 is a diagram illustrating an example of a configuration of a complex sequence generating system according to a second embodiment.

FIG. 9 is a flowchart illustrating a process performed by the complex sequence generating system.

FIG. 10 is a diagram illustrating an example of a hierarchical sequence.

FIG. 11 is a diagram illustrating an example of a configuration of a hierarchical sequence generating system according to a third embodiment.

FIG. 12 is a flowchart illustrating a process performed by the hierarchical sequence generating system.

### DESCRIPTION OF EMBODIMENTS

Exemplary embodiments of the present invention will now be described in detail with reference to the drawings. It is to be understood that the embodiments described herein are merely for illustrative purposes and are not intended to limit the scope of the present invention.

### First Embodiment

As a first embodiment of a sequence generating apparatus according to the present invention, a system that generates a single behavioral sequence representing a state transition related to a behavior of a single person (object) will be described as an example.

<Sequence>

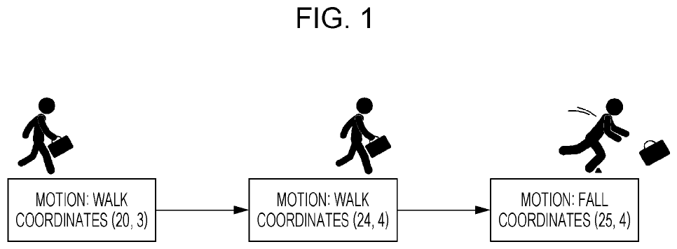

FIG. 1 is a diagram illustrating an example of a sequence. As element data of a single behavioral sequence, this example focuses on “motion” of a person, such as walk or fall, and “coordinates” representing the position of the person. Any items related to the behavior of a single person, such as speed and orientation, may be used as element data of a sequence.

A single behavioral sequence can be used to define the behavior of a character for generating a computer graphics (CG) video. For example, by setting a character model and animation, a CG video generating tool can generate a CG video. Since a single behavioral sequence corresponds to component elements of an animation, such as motion categories including walk and fall, and the coordinates of a character, a CG video in which the character acts can be generated by setting an animation using the single behavioral sequence. Such a CG video is applied to learning and evaluation in behavior recognition techniques based on machine learning.

The first embodiment describes an example in which a sequence is a single behavioral sequence. Here, the single behavioral sequence is simply referred to as a sequence. A sequence generating system according to the first embodiment generates one or more diverse and natural sequences on the basis of input sequences and various settings defined by the operator.

<Apparatus Configuration>

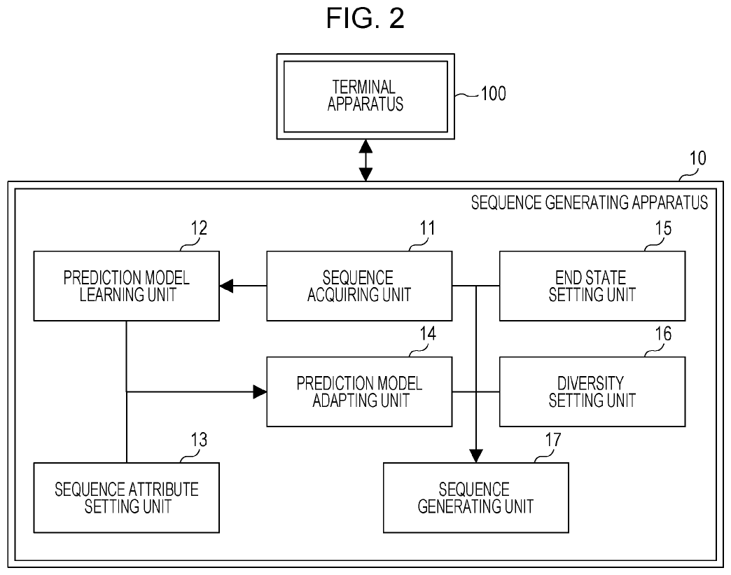

FIG. 2 is a diagram illustrating an example of a configuration of a sequence generating system according to the first embodiment. The sequence generating system includes a sequence generating apparatus 10 and a terminal apparatus 100. These apparatuses may be connected via a network. Examples of the network include a land-line phone network, a mobile phone network, and the Internet. One of these apparatuses may be contained in the other.

The terminal apparatus 100 is a computer apparatus used by the operator, and includes a display unit DS and an operation detector OP (which are not shown). Examples of the terminal apparatus 100 include a personal computer (PC), a tablet PC, a smartphone, and a feature phone.

The display unit DS includes an image display panel, such as a liquid crystal panel or an organic EL panel, and displays information received from the sequence generating apparatus 10. Examples of displayed contents include various types of sequence information and GUI components, such as buttons and text fields used for operation.

The operation detector OP includes a touch sensor disposed on the image display panel of the display unit DS. The operation detector OP detects an operator's operation based on the movement of an operator's finger or touch pen, and outputs operation information representing the detected operation to the sequence generating apparatus 10. The operation detector OP may include input devices, such as a controller, a keyboard, and a mouse, and acquire operation information representing an operator's input operation performed on contents displayed on the image display panel.

The sequence generating apparatus 10 is an apparatus that provides a user interface (UI) for inputting various settings and sequences, and generates diverse and natural sequences on the basis of various inputs received through the UI. The sequence generating apparatus 10 includes a sequence acquiring unit 11, a prediction model learning unit 12, a sequence attribute setting unit 13, a prediction model adapting unit 14, an end state setting unit 15, a diversity setting unit 16, and a sequence generating unit 17.

The sequence acquiring unit 11 acquires a pair of a sequence and a sequence attribute (described below) and outputs the acquired pair to the prediction model learning unit 12 and the sequence generating unit 17. The sequence attribute is static information that includes at least one item that is common within one sequence. Examples of the attribute item include an environment type, such as indoor or street setting, a movable region where a person can move, and the age and sex of a person of interest. Each item of the sequence attribute can be specified, for example, by a fixed value, numerical range, or probability distribution. The method for acquiring a sequence and a sequence attribute is not limited to a specific one. For example, they may be manually input through the terminal apparatus 100 by the operator, or may be extracted from images using an image recognition technique.

A given sequence used to learn a prediction model (described below) is called “learning sequence”, and a given sequence used in generating a sequence is called “reference sequence”. The learning sequence and the reference sequence include respective sequence attributes paired together. It is preferable that there be diverse learning sequences, which are therefore acquired extensively under various conditions. For example, many unspecified images obtained through the Internet may be acquired as learning sequences. On the other hand, the reference sequence is preferably a natural sequence and is acquired under conditions equal or similar to those of a sequence to be generated. For example, when a sequence corresponding to the image capturing environment of a monitoring camera is to be generated, the reference sequence may be acquired on the basis of images actually captured by the monitoring camera.

The prediction model learning unit 12 generates “prediction model” on the basis of learning using at least one learning sequence received from the sequence acquiring unit 11. The prediction model learning unit 12 then outputs the generated prediction model to the prediction model adapting unit 14.

The prediction model described here is a model that defines, under the condition that a sequence is given, information related to a sequence predicted to follow the given sequence. The information related to the predicted sequence may be, for example, a set of predicted sequences, or may be the occurrence probability distribution of the sequence. Here, the sequence predicted on the basis of the prediction model (i.e., the sequence generated by the sequence generating unit 17) is called “prediction sequence”. The number of element data items of the prediction sequence may be a fixed value or may vary arbitrarily. The prediction sequence may include only one element data item.

The form of the prediction model is not limited to a specific one. For example, the prediction model may be a probability model, such as a Markov decision model, or may be based on a state transition table. Deep learning may be used. For example, a continuous density hidden Markov model (HMM) using observed values as element data may be used as the prediction model. In this case, when a sequence is input, the observation probability distribution of element data can be generated after the sequence is observed. For example, when the element data includes motion categories and coordinates, the probability of each motion category and the probability distribution of coordinates are generated. This corresponds to the probability distribution of a prediction sequence that includes one element data item.

As described above, a prediction model is defined on the basis of learning using at least one learning sequence. By using the prediction model, therefore, it is possible to prevent generation of a strange and unnatural prediction sequence that is unlikely to be included as a learning sequence. For example, if a walking motion with frequent change of direction is not included as a learning sequence, a similar sequence is less likely to be generated as a prediction sequence. On the other hand, many behaviors included as learning sequences are more likely to be generated as a prediction sequence.

For “output sequence” to be output by the sequence generating system, the sequence attribute setting unit 13 sets a sequence attribute, such as a movable region or an age, and outputs the set sequence attribute to the prediction model adapting unit 14. Here, the sequence attribute set by the sequence attribute setting unit 13 is called an output sequence attribute.

The output sequence attribute is set, for example, by the operator's direct input through the terminal apparatus 100. Alternatively, the output sequence attribute may be set by reading a predefined setting file. Examples of other methods may include reading reference sequences to extract a sequence attribute common among the read reference sequences, and setting the extracted attribute as an output sequence attribute. The output sequence attribute may be displayed, through a UI, in the display unit DS of the terminal apparatus 100.

The prediction model adapting unit 14 adapts a prediction model on the basis of the output sequence attribute, and outputs the adapted prediction model to the sequence generating unit 17. That is, depending on the sequence attribute of the learning sequence, the prediction model generated by the prediction model learning unit 12 does not necessarily match the output sequence attribute. For example, if a movable region is set as the output sequence attribute, it is normally unlikely that movement to an immovable region, such as a wall interior, will take place. To deal with such a situation, for example, the prediction model is adapted to remove the coordinates of wall interiors from destinations. That is, by changing the prediction model such that a sequence inconsistent with the output sequence attribute is not included in the prediction, the prediction model is adapted to the output sequence attribute. The method for such adaptation is not limited to a specific one. For example, learning sequences having the same sequence attribute as the output sequence attribute may be extracted, and only the extracted learning sequences may be used to learn the prediction model. If the prediction model is defined by a probability distribution, the probabilities of portions inconsistent with the output sequence attribute may be changed to “0.0”.

The end state setting unit 15 sets an end state that is a set of candidates for, or a condition of, an end portion of the output sequence, and outputs the set end state to the sequence generating unit 17. The operator may set any item as the end state. For example, the end state may be a set of element data items or sequences, the type of motion category, or the range of coordinates at the end. A plurality of items may be set at the same time. The end state setting unit 15 provides a UI that allows the operator to set an end state and visualize the set end state. The UI may be a command UI (CUI) or a graphical UI (GUI).

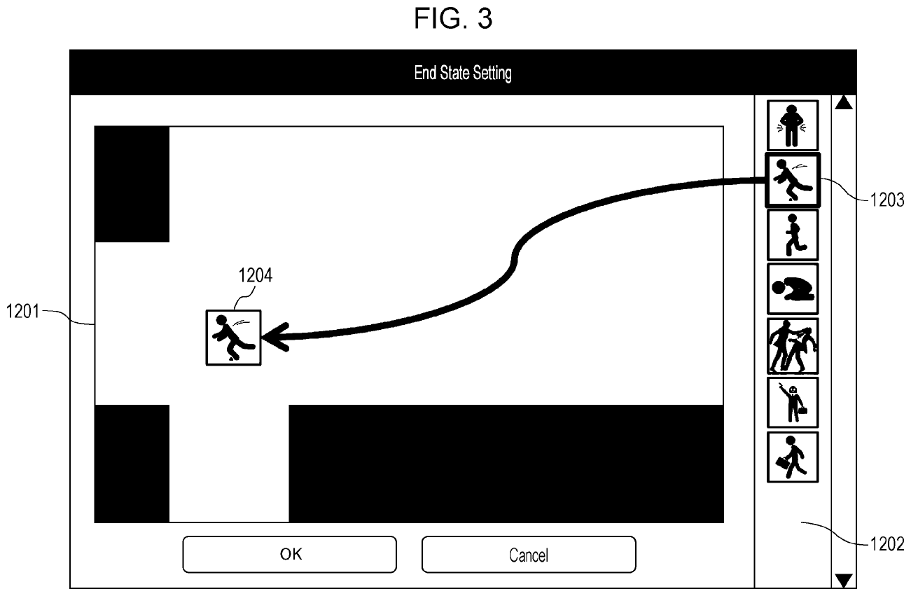

FIG. 3 is a diagram illustrating an example of a GUI of the end state setting unit 15. Specifically, a GUI for specifying “motion category” and “coordinates” as an end state is shown. In particular, as a sequence attribute of a behavioral sequence, “movable region” defining the ambient environment of a person (object) is set in this case. A region 1201 displays a map that shows a movable region set as the output sequence attribute. In the drawing, an empty (or white) area represents a movable region, and a filled (or black) area represents an immovable region, such as a wall, which does not allow a person to pass through.

A region 1202 displays a given list of icons representing motion categories of the end state. Clicking on or tapping a desired icon allows the user to select a motion category in the end state.

An icon 1203 is a selected motion category icon highlighted, for example, with a thick frame. An icon 1204 indicates a result of movement of the selected icon 1203 to the movable region on the map. This can be done, for example, by a drag-and-drop action using a mouse. The coordinates of the icon correspond to coordinates in the end state. Icons are allowed to be placed only in the movable region on the map. This prevents setting of an end state inconsistent with the sequence attribute. The GUI described above thus allows setting of motion categories and coordinates in the end state. The UI of the end state setting unit 15 is not limited to the example illustrated in FIG. 3, and any UI can be used.

The diversity setting unit 16 provides a UI for setting a diversity parameter that controls the level (degree) of diversity of sequences generated by the sequence generating system, and outputs the set diversity parameter to the sequence generating unit 17. The diversity parameter may be in various forms. For example, the diversity parameter may be a threshold for the prediction probability of the prediction model, dispersion of each element data item, such as coordinates, or a threshold for the level in the ranking of generation probability based on the prediction probability. The diversity setting unit 16 receives the input of a diversity parameter from the operator through the UI. The UI of the diversity setting unit 16 may be for displaying and inputting diversity parameter items, or may be for displaying and inputting the abstracted degree of diversity and adjusting the diversity parameters on the basis of the degree of diversity.

Although the sequence generating system is capable of generating diverse and natural sequences, the required level of diversity varies depending on the purpose. Also, diversity and naturalness have a trade-off relation. That is, as diversity increases, it becomes more likely that less natural sequences will be generated, whereas as diversity decreases, it becomes more likely that only natural sequences will be generated. Controlling the diversity is thus important in automatically generating sequences. It can be expected that using diversity parameters can facilitate generation of sequences that are appropriate for the purpose.

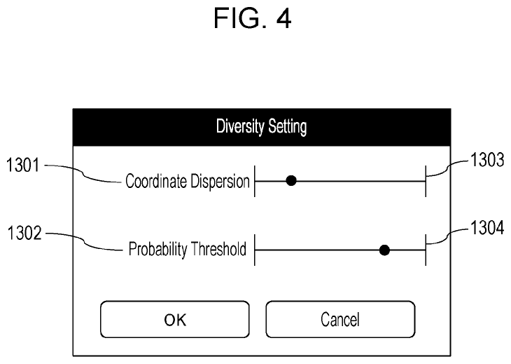

FIG. 4 is a diagram illustrating an example of a GUI of the diversity setting unit 16. Specifically, FIG. 4 illustrates a GUI for setting, as diversity parameters, “coordinate dispersion” which is an element data item and “probability threshold” for varying the defined motion category depending on the prediction model.

Items 1301 and 1302 are parameter items each for setting the degree of diversity. Specifically, the item 1301 receives setting of “coordinate dispersion”, and the item 1302 receives setting of “probability threshold” for the prediction sequence. In this example, values of these items are received by a slider 1303 and a slider 1304. Manipulating the corresponding slider of each item allows the operator to set the diversity parameter. The UI of the diversity setting unit 16 is not limited to the example illustrated in FIG. 4, and any UI can be used. For example, a result of changes made to the diversity parameters may be displayed for preview.

On the basis of the prediction model, end state, diversity parameter, and at least one reference sequence, the sequence generating unit 17 generates an output sequence having the reference sequence as the initial state. Then, an output sequence that matches the set end state is output as a result of processing by the entire sequence generating system.

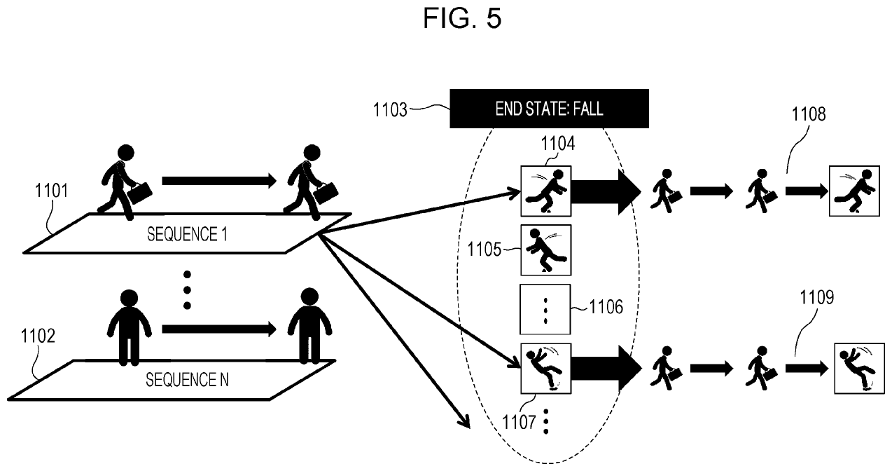

FIG. 5 is a diagram illustrating examples of processing steps of the sequence generating unit 17. Sequences 1101 and 1102 each represent a reference sequence. When there are a plurality of reference sequences, the sequence generating unit 17 selects and uses at least one of the reference sequences. The selected reference sequence is used to generate information about a prediction sequence based on the prediction model, that is, to generate a set of prediction sequences or the occurrence probability distribution of the prediction sequence.

An end state 1103 indicates setting of an end state of an output sequence, and icons 1104 to 1107 each represent an exemplary end state. The end state is either “set of end candidates” or “end condition”. If the end state is a set of end candidates, the end state is used to remove any prediction sequence that does not match the end state. If the end state is an end condition, the end state is used to correct the prediction model. For example, the prediction model is corrected by changing the occurrence probability distribution of the prediction sequence inconsistent with the end state to “0.0”.

Additionally, on the basis of a diversity parameter, the sequence generating unit 17 generates, as an output sequence, only a prediction sequence that matches a condition indicated by the diversity parameter. For example, if “coordinate dispersion” is set as the diversity parameter, a prediction sequence exceeding the set coordinate dispersion is removed from the set of prediction sequences. If “probability threshold” is set as the diversity parameter, part of the probability distribution of the prediction sequence below the threshold is excluded from the target to be generated. Thus, when the occurrence probability distribution of the prediction sequence that matches various conditions is obtained, the prediction sequence is generated on the basis of the probability distribution.

The prediction sequence eventually generated is combined with the selected reference sequence to generate “output sequence”. Sequences 1108 and 1109 are examples of the generated output sequence. If there is no prediction sequence corresponding to the reference sequence, the reference sequence is excluded from the target to be selected. The method for selecting a reference sequence is not limited to a specific one. For example, the selection may be randomly made, or the degrees of similarity between selected reference sequences may be generated to select reference sequences with lower degrees of similarity. There may be reference sequences that are not selected. A prediction sequence candidate may be selected as a new reference sequence. In the selection of a reference sequence, any part between the start and end points of a reference sequence may be selected and used.

<Operation of Apparatus>

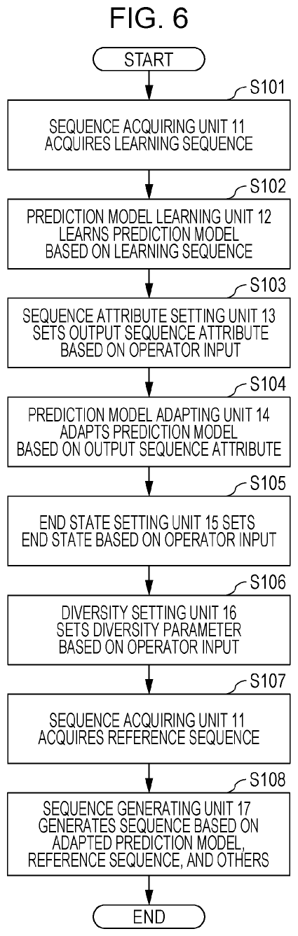

FIG. 6 is a flowchart illustrating a process performed by the sequence generating system. The flow of sequence generation includes the steps of acquiring a learning sequence, learning a prediction model, setting an output sequence attribute, adapting the prediction model, setting an end state, setting a diversity parameter, acquiring a reference sequence, and generating a sequence.

In step S101, the sequence acquiring unit 11 acquires, as a learning sequence, at least one pair of a sequence and a sequence attribute used for leaning a prediction model. In step S102, the prediction model learning unit 12 generates a learned prediction model based on the learning sequence.

In step S103, the sequence attribute setting unit 13 sets an output sequence attribute. In step S104, the prediction model adapting unit 14 adapts the learned prediction model to an output sequence attribute to generate a predetermined prediction model.

In step S105, the end state setting unit 15 sets an end state of a sequence to be generated. In step S106, the diversity setting unit 16 sets a diversity parameter of the sequence to be generated. In step S107, the sequence acquiring unit 11 acquires a reference sequence.

In step S108, the sequence generating unit 17 generates at least one output sequence on the basis of the adapted prediction model, the end state, the diversity parameter, and at least one reference sequence.

In the first embodiment, as described above, an output sequence is automatically generated on the basis of the end state, the diversity parameter, and the output sequence attribute. This allows the operator to acquire a desired sequence with less work. By generating an output sequence on the basis of the reference sequence, a natural sequence which gives less feeling of strangeness can be generated. Additionally, by generating an output sequence on the basis of prediction sequence information (e.g., a set of prediction sequences, or the occurrence probability distribution of a prediction sequence), diverse sequences can be generated within the range of prediction sequences.

By making the diversity parameter and the output sequence attribute adjustable, it is possible to provide adjustment that can maintain diversity appropriate for the purpose without loss of naturalness.

### Second Embodiment

A second embodiment describes a configuration for generating a complex sequence. Here, the complex sequence refers to a set of sequences interacting with each other. Each of sequences included in the complex sequence is called an individual sequence. The number of element data items of each individual sequence may be any value. Each individual sequence is provided with an index indicating the timing of the start point.

The second embodiment describes a complex sequence representing behaviors of multiple persons. In the present embodiment, a complex sequence representing a state transition related to behaviors of multiple persons is called a complex behavioral sequence. Each of individual sequences included in the complex behavioral sequence corresponds to the single behavioral sequence described in the first embodiment.

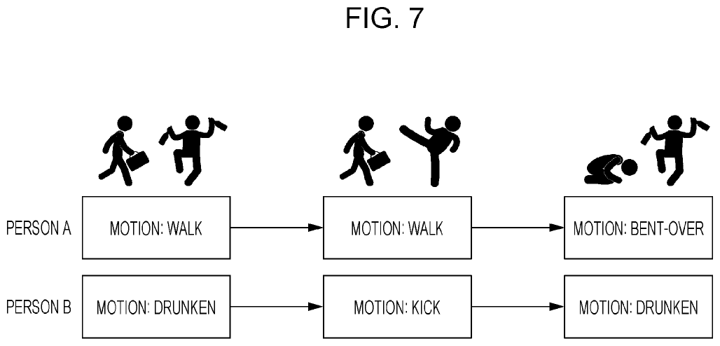

FIG. 7 is a diagram illustrating an example of a complex sequence. A complex behavioral sequence for two persons is illustrated here. More specifically, how person A (pedestrian) is assaulted by person B (drunken) is shown as single behavioral sequences of the respective persons. Element data includes “motions”, such as walk and kick.

Like the single behavioral sequence in the first embodiment, the complex behavioral sequence can be used to generate a CG video, and can be used particularly when multiple persons interact with each other. Such CG videos are applicable to learning and evaluation in behavior recognition techniques based on machine learning. Complex behavioral sequences can also be used to analyze collective behaviors, such as sports games and evacuation behaviors in disasters.

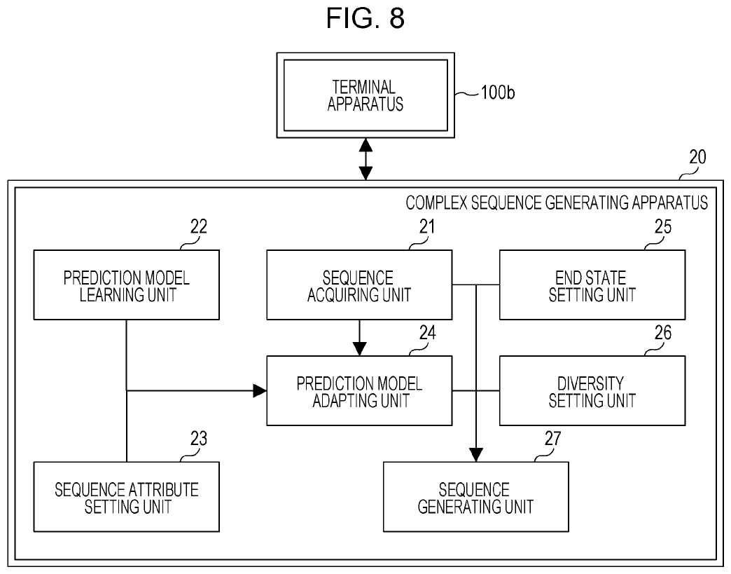

FIG. 8 is a diagram illustrating an example of a configuration of a complex sequence generating system according to a second embodiment. Component elements are similar to those illustrated in the first embodiment, but some of their operations differ from those in the first embodiment. As illustrated in FIG. 8, the complex sequence generating system according to the present embodiment includes a complex sequence generating apparatus 20 and a terminal apparatus 100b. These apparatuses may be connected via a network. Examples of the network include a land-line phone network, a mobile phone network, and the Internet. One of these apparatuses may be contained in the other.

The terminal apparatus 100b is a computer apparatus similar to the terminal apparatus 100 illustrated in the first embodiment. The terminal apparatus 100b is used by the operator to input and output various types of information for the complex sequence generating system according to the present embodiment.

The complex sequence generating apparatus 20 is an apparatus that provides a UI for various types of setting and data entry, and generates diverse and natural complex sequences on the basis of various inputs received through the UI. The complex sequence generating apparatus 20 includes a sequence acquiring unit 21, a prediction model learning unit 22, a sequence attribute setting unit 23, a prediction model adapting unit 24, an end state setting unit 25, a diversity setting unit 26, and a sequence generating unit 27.

The sequence acquiring unit 21 acquires a learning sequence and a reference sequence. The learning sequence and the reference sequence in the second embodiment are both complex sequences. A method for acquiring the learning sequence and the reference sequence is not limited to a specific one. For example, they may be manually input by the operator, automatically extracted from a video using a behavior recognition technique, or acquired through recorded data of a sports game.

The prediction model learning unit 22 learns a prediction model on the basis of the learning sequence, and outputs the prediction model to the prediction model adapting unit 24. The prediction model of the present embodiment partially differs from the prediction model of the first embodiment, and predicts individual sequences under the condition that a complex sequence is given. This enables generation of a prediction sequence based on interactions between the individual sequences. In generating a prediction sequence using the prediction model, an individual sequence in the complex sequence is selected and a prediction sequence following the selected individual sequence is generated.

The sequence attribute setting unit 23 sets an output sequence attribute and outputs the set output sequence attribute to the prediction model adapting unit 24. In the present embodiment, the output sequence attribute may include the number of individual sequences. The output sequence attribute may be independently set for each of the individual sequences. For example, in outputting sequences of a soccer game, the numbers of players and balls may be set to individually set a corresponding output sequence attribute. Output sequence attributes that are common among a plurality of individual sequences may be set together as common output sequence attributes.

The prediction model adapting unit 24 adapts the prediction model to the output sequence attribute and outputs the adapted prediction model to the sequence generating unit 27. When a plurality of output sequence attributes are set, the prediction model may be adapted independently to each of the output sequence attributes and output as a plurality of different prediction models.

The end state setting unit 25 sets an end state and outputs the set end state to the sequence generating unit 27. The end state in the present embodiment may be, for example, “goal is scored” or “offside occurs” in sequences for a soccer game. The end state setting unit 25 may set an end state independently for each individual sequence. For example, an individual sequence corresponding to a ball may be “coordinates are in the goal”.

The diversity setting unit 26 provides a UI for setting a diversity parameter that controls the diversity of sequences generated by the complex sequence generating system, and outputs the set diversity parameter to the sequence generating unit 27. The diversity parameter in the present embodiment may be set independently for each individual sequence, or may be set as a common diversity parameter.

On the basis of the prediction model, end state, diversity parameter, and reference sequence, the sequence generating unit 27 generates and outputs a complex sequence. Specifically, the sequence generating unit 27 selects a prediction model corresponding to each individual sequence in the reference sequence on the basis of a sequence attribute, and generates a prediction sequence for each individual sequence. The sequence generating unit 27 then generates one or more individual sequences predicted from a common reference sequence, and forms or generates a complex sequence using a combination of individual sequences that match the end state.

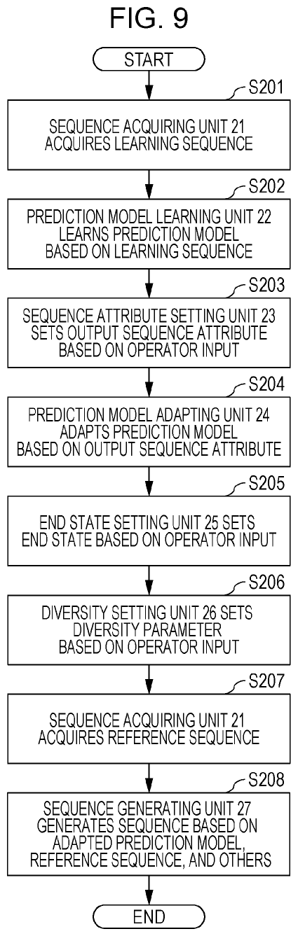

FIG. 9 is a flowchart illustrating a process performed by the complex sequence generating system. The flow of complex sequence generation in the present embodiment includes the steps of acquiring a learning sequence, learning a prediction model, setting an output sequence attribute, adapting the prediction model, setting an end state, setting a diversity parameter, acquiring a reference sequence, and generating a sequence.

In step S201, the sequence acquiring unit 21 acquires a learning sequence used for leaning a prediction model. In step S202, the prediction model learning unit 22 learns a prediction model based on the learning sequence.

In step S203, the sequence attribute setting unit 23 sets an output sequence attribute. In step S204, the prediction model adapting unit 24 changes and adapts the prediction model in accordance with the output sequence attribute.

In step S205, the end state setting unit 25 sets an end state of an output sequence. In step S206, the diversity setting unit 26 sets a diversity parameter for the output sequence. In step S207, the sequence acquiring unit 21 acquires a reference sequence.

In step S208, the sequence generating unit 27 generates an output sequence on the basis of the adapted prediction model, end state, diversity parameter, and reference sequence.

As described above, in the second embodiment, a complex sequence is automatically generated on the basis of the end state, diversity parameter, and output sequence attribute. This allows the operator to acquire a desired complex sequence with less work.

Also, a prediction model is learned by taking into account interactions between multiple objects to generate a complex sequence. Thus, without requiring the operator to input details of interactions between objects, a complex sequence which takes into account interactions between objects can be generated.

### Third Embodiment

A third embodiment describes a configuration for generating a hierarchical sequence. Here, the hierarchical sequence refers to a sequence composed of a plurality of sequences having a hierarchical structure. In the third embodiment, person's travel between buildings will be described as a hierarchical sequence.

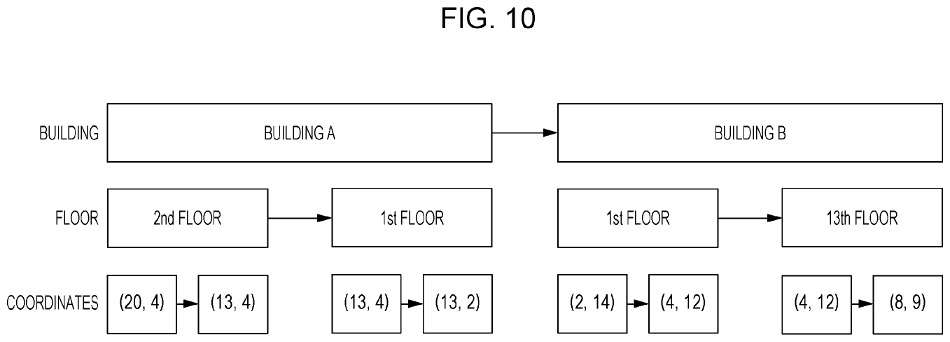

FIG. 10 is a diagram illustrating an example of a hierarchical sequence. A hierarchical sequence representing a state transition related to person's travel is illustrated here. FIG. 10 illustrates a sequence composed of three levels: building, floor, and coordinates. Specifically, the sequence illustrated here is a hierarchical sequence that represents travel from the second floor of building A to the thirteenth floor of building B.

Element data includes building, floor, and coordinates. The coordinates are defined for each floor, and the floor is defined for each building. Thus, the hierarchical sequence is a structural representation of elements having an inclusive relation, such as building, floor, and coordinates.

Like building, floor, and coordinates in FIG. 10, different positions in a hierarchical sequence, each having the same type of element data, are called levels. A level including another level is called an upper level, and a level included in another level is called a lower level. For example, “building” and “coordinates” are an upper level and a lower level, respectively, with respect to “floor”.

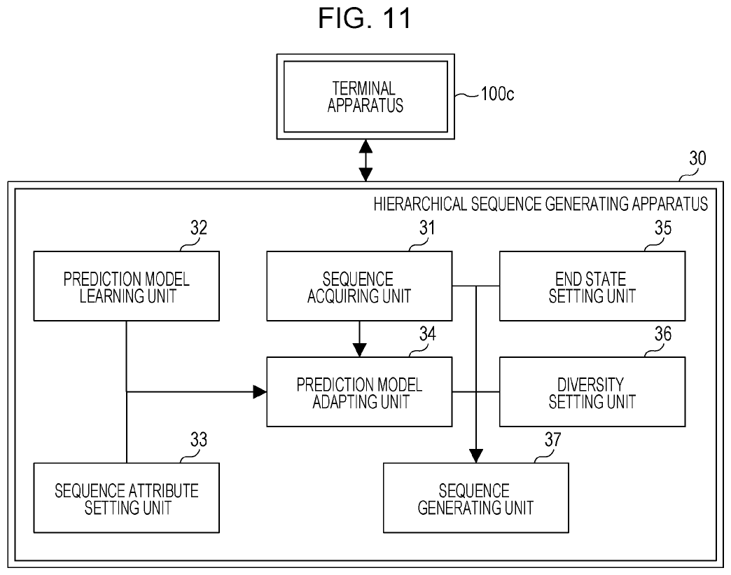

FIG. 11 is a diagram illustrating an example of a configuration of a hierarchical sequence generating system according to a third embodiment. Since component elements include the same parts as those illustrated in the first embodiment, only differences will be described here. As illustrated in FIG. 11, the hierarchical sequence generating system according to the present embodiment includes a hierarchical sequence generating apparatus 30 and a terminal apparatus 100c. These apparatuses may be connected via a network. Examples of the network include a land-line phone network, a mobile phone network, and the Internet. One of these apparatuses may be contained in the other.

The terminal apparatus 100c is a computer apparatus similar to the terminal apparatus 100 illustrated in the first embodiment. The terminal apparatus 100c is used by the operator to input and output various types of information for the hierarchical sequence generating system according to the present embodiment.

The hierarchical sequence generating apparatus 30 is an apparatus that provides a UI for various types of setting and data entry, and generates one or more diverse and natural hierarchical sequences on the basis of various inputs received through the UI. The hierarchical sequence generating apparatus 30 includes a sequence acquiring unit 31, a prediction model learning unit 32, a sequence attribute setting unit 33, a prediction model adapting unit 34, an end state setting unit 35, a diversity setting unit 36, and a sequence generating unit 37.

The sequence acquiring unit 31 acquires a learning sequence and a reference sequence and outputs them to the prediction model learning unit 32 and the sequence generating unit 37. The learning sequence and the reference sequence acquired by the sequence acquiring unit 31 are both hierarchical sequences. The sequence acquiring unit 31 may convert sequences to hierarchical sequences using a technique for recognizing a hierarchical structure.

The prediction model learning unit 32 learns a prediction model on the basis of the learning sequence, and outputs the prediction model to the prediction model adapting unit 34. The prediction model in the present embodiment is learned for each level of the hierarchical sequence. The prediction model for each level generates a prediction sequence on the basis of element data of the sequence for the corresponding level and element data of the sequence for the upper level.

For example, in the case of a hierarchical sequence corresponding to building, floor, and coordinates, such as that illustrated in FIG. 10, the definition for each level is made on the basis of the element data of the upper level, in such a manner as “building”, “floor of building A”, and “coordinates of the first floor of building A”. The prediction model may be defined independently for each element data of the upper level, or may be defined as a single prediction model that changes on the basis of the element data of the upper level.

The sequence attribute setting unit 33 provides a UI that allows the operator to set an output sequence attribute, and outputs the set output sequence attribute to the prediction model adapting unit 34. The output sequence attribute may be set independently for each level of the hierarchical sequence, or may be set as a common output sequence attribute.

The prediction model adapting unit 34 changes and adopts the prediction model on the basis of the output sequence attribute, and outputs the resulting prediction model to the sequence generating unit 37. The prediction model adapting unit 34 performs adaptation processing on the prediction model corresponding to each level.

The end state setting unit 35 sets an end state and outputs the set end state to the sequence generating unit 37. The end state may be set for each level, or may be set only for a specific level. The end state may be automatically set on the basis of the sequence for the upper level. For example, when the sequence for the upper level changes from “building A” to “building B”, then “first floor”, which allows travel between buildings, is set as the end state for the floor at the lower level. Information for automatically setting the end state may be set by extracting the element data for the end portion from the learning sequence, or may be manually set.

The diversity setting unit 36 provides a UI for setting a diversity parameter that controls the diversity of hierarchical sequences generated by the hierarchical sequence generating system, and outputs the set diversity parameter to the sequence generating unit 37. The diversity parameter in the present embodiment may be set independently for element data corresponding to each level, or may be set only for a specific level.

The sequence generating unit 37 generates a sequence for each level on the basis of the prediction model, end state, diversity parameter, and reference sequence, and outputs a hierarchical sequence as a result of processing by the entire hierarchical sequence generating system. The sequence generating unit 37 generates the hierarchical sequence, in order from the upper level, by generating the sequence for the lower level on the basis of the sequence for the upper level.

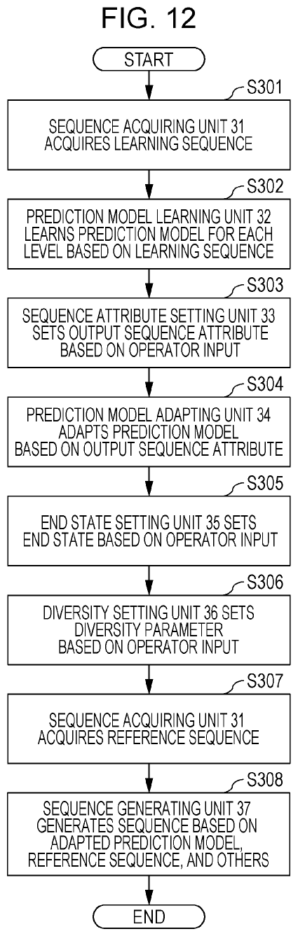

FIG. 12 is a flowchart illustrating a process performed by the hierarchical sequence generating system. The flow of hierarchical sequence generation includes the steps of acquiring a learning sequence, learning a prediction model, setting an output sequence attribute, adapting the prediction model, setting an end state, setting a diversity parameter, acquiring a reference sequence, and generating a sequence.

In step S301, the sequence acquiring unit 31 acquires a learning sequence used for leaning a prediction model. In step S302, the prediction model learning unit 32 learns, for each level, a prediction model based on the learning sequence.

In step S303, the sequence attribute setting unit 33 sets an output sequence attribute. In step S304, the prediction model adapting unit 34 adapts the prediction model for each level in accordance with the output sequence attribute.

In step S305, the end state setting unit 35 sets an end state. In step S306, the diversity setting unit 36 sets a diversity parameter. In step S307, the sequence acquiring unit 31 acquires a reference sequence.

In step S308, the sequence generating unit 37 generates an output sequence in order from the upper level, on the basis of the adapted prediction model, end state, diversity parameter, and reference sequence.

As described above, in the third embodiment, a hierarchical sequence is automatically generated on the basis of the end state, diversity parameter, and output sequence attribute. This allows the operator to acquire a desired hierarchical sequence with less work.

Also, the hierarchical sequence generating system according to the present embodiment generates a sequence, in order from the upper level, in such a manner that the sequence for the lower level is generated on the basis of the sequence for the upper level. The range of generation of the prediction sequence is thus narrowed down to each level, and a hierarchical sequence can be efficiently generated.

### Other Embodiments

The present invention can also be implemented by processing where a program that performs at least one of the functions of the embodiments described above is supplied to a system or apparatus via a network or storage medium and at least one processor in a computer of the system or apparatus reads and executes the program. The present invention can also be implemented by a circuit (e.g., ASIC) that performs the at least one function.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A sequence generating apparatus that generates a sequence representing a state transition of an object, the sequence generating apparatus comprising:
input unit configured to input an initial state of the object in a sequence to be generated;
setting unit configured to set an end state of the object in the sequence to be generated;
generating unit configured to generate a plurality of sequences using a predetermined prediction model on the basis of the initial state, the plurality of sequences matching the end state; and
output unit configured to output at least one of the plurality of sequences, the at least one sequence matching the end state.

2. The sequence generating apparatus according to claim 1, wherein the input unit inputs a given reference sequence as the initial state, the given reference sequence being specified by a user.

3. The sequence generating apparatus according to claim 1, wherein the setting unit sets as the end state, at least one of given end candidates selected by a user.

4. The sequence generating apparatus according to claim 1, further comprising learning unit configured to learn a learning sequence to generate a prediction model.

5. The sequence generating apparatus according to claim 4, further comprising attribute setting unit configured to set a common attribute common among sequences to be generated.

6. The sequence generating apparatus according to claim 5, further comprising adapting unit configured to adapt a learned prediction model obtained by learning the learning sequence, to the common attribute to generate the predetermined prediction model.

7. The sequence generating apparatus according to claim 5, wherein the common attribute includes at least one of an attribute of the object and an attribute of an ambient environment of the object.

8. The sequence generating apparatus according to claim 5, wherein the input unit prevents input of an initial state not matching the common attribute.

9. The sequence generating apparatus according to claim 5, wherein the setting means prevents setting of an end state not matching the common attribute.

10. The sequence generating apparatus according to claim 5, wherein the attribute includes an environment type.

11. The sequence generating apparatus according to claim 5, wherein the object is a person, and the attribute includes an age or sex of the person.

12. The sequence generating apparatus according to claim 5, wherein the attribute includes a movable region of the object, the movable region being a region where the object can move.

13. The sequence generating apparatus according to claim 1, further comprising diversity setting unit configured to set a degree of diversity of sequences to be generated by the generating unit,
wherein the generating unit changes the diversity of sequences to be generated on the basis of the degree.

14. The sequence generating apparatus according to claim 1, wherein the object is a person, and the state transition is a behavior of the person.

15. The sequence generating apparatus according to claim 14, wherein the sequences each include a type of each motion in the behavior and a position where the motion takes place.

16. The sequence generating apparatus according to claim 1, wherein the generating means generates a complex sequence being a set of sequences interacting with each other.

17. The sequence generating apparatus according to claim 1, wherein the generating unit generates a hierarchical sequence composed of a plurality of sequences having a hierarchical structure.

18. The sequence generating apparatus according to claim 17, wherein the generating unit generates a sequence for a level on the basis of an element of a sequence for an upper level.

19. A method for generating a sequence representing a state transition of an object comprising:
inputting an initial state of the object in a sequence to be generated;
setting an end state of the object in the sequence to be generated;
generating a plurality of sequences using a predetermined prediction model on the basis of the initial state; and
outputting at least one of the plurality of sequences, the at least one sequence matching the end state.

20. A non-transitory computer readable storage medium storing a program for causing a computer to generate a sequence representing a state transition of an object, to serve as:
input unit configured to input an initial state of the object in a sequence to be generated;
setting unit configured to set an end state of the object in the sequence to be generated;
generating unit configured to generate a plurality of sequences using a predetermined prediction model on the basis of the initial state, the plurality of sequences matching the end state; and
output unit configured to output at least one of the plurality of sequences, the at least one sequence matching the end state.
